(19) United States
(12) Patent Application Publication
(10) Pub. No.: US 2026/0215998 A1
(43) Pub. Date: Jul. 30, 2026

(54) Sauna Room

(71) Applicants: Yasutaka KATO, Tokyo (JP); Spa Garage Co. Ltd., Tokyo (JP)

(72) Inventors: Yu TATEISHI, Tokyo (JP); Yasutaka KATO, Tokyo (JP)

(21) Appl. No.: 19/457,377

(22) Filed: Jan. 23, 2026

(30) Foreign Application Priority Data
Jan. 29, 2025 (JP) 2025-012857

(51) Int. Cl. A61H 33/00; A61H 33/06

(52) U.S. Cl. CPC A61H 33/0095; A61H 33/6021; A61H 2033/068; A61H 2201/0207; A61H 2201/0214; A61H 2201/0228; A61H 2201/0264; A61H 2201/5035; A61H 2201/5082; A61H 2203/0425

(57) ABSTRACT

A sauna room allows a user to experience a sauna state and a cold-water bath state without moving. The sauna room has a first wall surface and a second wall surface, and includes a first heating sheet disposed on a seating surface and electrically switchable between ON and OFF states, a second heating sheet (33) disposed on at least one of the first wall surface and the second wall surface adjacent to the seating surface and electrically switchable between ON and OFF states, a body shower between a first side of the seating surface and the first wall surface or between a second side of the seating surface and the second wall surface or both. The body shower is configured to spray and stop cold water through one or more nozzles. A control unit is configured to control the first heating sheet, the second heating sheet, and the body shower.

### BACKGROUND

The disclosed embodiments relate to a sauna room in which a user can experience, within a single room and without moving, at least a sauna state, a cold-water bath state, and a resting state (either outdoor air bathing or indoor air bathing).

In recent years, saunas provided for the purpose of promoting perspiration in users and improving health have often been installed in combination with facilities such as hot springs, and are widely used by many people seeking a refreshing feeling after bathing. Various studies have been conducted on personal saunas that can be easily used in homes or the like without the need to visit such facilities.

The capsule sauna or ganbanyoku (hot stone spa) bed described in JP patent publication 2010125201A or JP Utility Patent 3137979 promotes perspiration of a user within the capsule sauna or the ganbanyoku bed.

### SUMMARY

A user typically enters a sauna room to warm the body, then exits the sauna room to cool the body by means of a cold-water shower or a water bath (cold-water bath), and thereafter sits on a chair or the like to slowly take a rest (being exposed to outdoor air or indoor air, hereinafter collectively referred to as “resting”). Generally, one set includes a progression of: (1) sauna to (2) cold-water bath to (3) resting, and the user repeats two or more sets.

For this reason, in the capsule sauna described in JP patent publication 2010125201A or the ganbanyoku bed described in JP Utility Patent 3137979, there has been a problem in that the user must move by exiting the capsule or bed, taking a cold-water bath or resting, and then re-entering the capsule sauna or ganbanyoku bed. In addition, in a household sauna, even if a sauna is installed, there is usually only one bathtub, and when it is used as a cold-water bathtub, it cannot be used as a hot-water bathtub. Furthermore, regarding the cold-water bath, when tap water is used, there is a problem that, particularly in summer, the water temperature exceeds 20° C., resulting in a relatively high temperature for a cold-water bath.

Accordingly, the disclosure provides a sauna room in which at least a sauna state and a cold-water bath state can be experienced without moving from a single room.

The sauna room according to the present embodiment is a sauna room that creates a sauna state and a cold-water bath state within a single room having a first wall surface and a second wall surface. The sauna room includes: a first heating sheet disposed on a seating surface and electrically switchable ON/OFF; a second heating sheet disposed on at least one of the first wall surface and the second wall surface adjacent to the seating surface and electrically switchable ON/OFF; a body shower disposed on at least one of between a first side of the seating surface and the first wall surface and between a second side of the seating surface and the second wall surface, the body shower being configured to spray and stop cold water through one or more nozzles; and a control unit that controls the first heating sheet, the second heating sheet, and the body shower. In the sauna state, the control unit turns ON the first heating sheet and the second heating sheet. In the cold-water bath state, the control unit keeps the first heating sheet and the second heating sheet ON and sprays water from the body shower.

The sauna room according to the present embodiment may further include a superheated steam nozzle disposed around the seating surface and capable of spraying and stopping superheated steam. The control unit sprays superheated steam from the superheated steam nozzle in the sauna state and stops the superheated steam nozzle in the cold-water bath state.

The control unit may set the first heating sheet to a first temperature and the second heating sheet to a second temperature higher than the first temperature in the sauna state.

The body shower preferably has a shape in which a pipe extends in a longitudinal direction and is disposed along the longitudinal direction of the seating surface.

The sauna room according to the present embodiment may further include a ventilation device disposed in the sauna room and capable of switching between a warm-air mode, a ventilation mode, and a cool-air mode. The control unit may set the ventilation device to the warm-air mode in the sauna state.

The sauna room according to the present embodiment may further include a ventilation device disposed in the sauna room and capable of switching between a warm-air mode, a ventilation mode, and a cool-air mode, and a temperature sensor disposed in the sauna room for measuring an indoor temperature of the sauna room. The sauna room may further be capable of creating an outdoor air bathing state, and in the resting state, the control unit may switch the ventilation device to the warm-air mode, the ventilation mode, or the cool-air mode and cause air to be blown in accordance with the indoor temperature of the sauna room measured by the temperature sensor, and may stop spraying of the body shower.

At the start of transition to the sauna state, the control unit turns ON the first heating sheet and the second heating sheet, and causes the ventilation device to blow air in the warm-air mode.

By using the disclosed sauna room, a user can experience at least a sauna state and a cold-water bath state without moving from a single room or while remaining seated on the seating surface.

### BRIEF DESCRIPTION OF THE DRAWINGS

FIG. 1A is a view showing the interior of the sauna room as seen from a side.

FIG. 1B is a view showing the interior of the sauna room as seen from the ceiling.

FIG. 2 is a conceptual diagram showing control of a ventilation device 20, a first heating sheet 30, a body shower, and the like disposed in the sauna room.

FIG. 3 is a flowchart showing a method of using the sauna room 10 from a sauna state to a cold-water bath state and then to a resting state.

FIG. 4 is a flowchart showing a method of using the sauna room 10 between a sauna state and a resting state.

FIG. 5 is a flowchart showing a method of using the sauna room 10 between a cold-water bath state and a resting state.

### DETAILED DESCRIPTION

Hereinafter, embodiments will be described in detail with reference to the drawings. In the present specification and drawings, components having substantially the same functional configuration are denoted by the same reference numerals, and redundant descriptions thereof are omitted. In addition, in each drawing, components are not drawn to actual dimensions in order to emphasize the members.

### Overview of Sauna Room

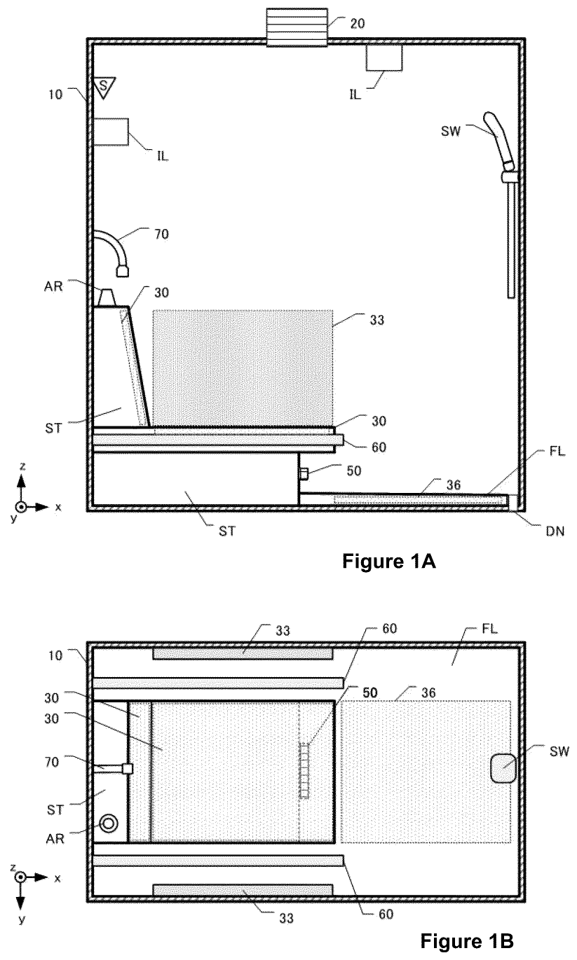

FIG. 1A is a view showing the interior of a sauna room 10 as seen from a side. Although not illustrated, windows or skylights may be provided in wall surfaces or a ceiling surface. The wall surfaces and the ceiling surface are formed of waterproof-treated wood, plasterboard, or the like, and are covered with a moisture-resistant heat insulating material such as rock wool. In addition, an entrance/exit door (not illustrated) is provided in a wall surface. FIG. 1B is a view showing an internal structure of the sauna room 10 as seen from the ceiling, and in FIG. 1B, a ventilation device, lighting fixtures, and the like are not illustrated.

The sauna room 10 is disposed indoors or outdoors of a building, and is, for example, a closed space formed by a ceiling and walls on a floor surface FL having an area of 2 m² to 10 m². In the case of a steam sauna, a set temperature of the sauna room 10 is set in a range from 40° C. to 80° C. The sauna room 10 can be used for commercial use or household use. As shown in FIG. 1A, a temperature sensor S for measuring an indoor temperature is disposed in the sauna room 10. The temperature sensor S is preferably disposed on a wall at a height of 1.6 m to 2.0 m away from the entrance/exit door so as not to be affected by an outside environment.

In the sauna room 10, a reclining chair (bench) or stairs having about two to three steps (hereinafter, the reclining chair and the stairs are collectively referred to as a “seating surface”) is provided so that a user can sit or lie down. In addition, it is preferable to install an emergency button (not illustrated) in the sauna room 10 in case the user feels unwell in the sauna room. In the present embodiment, use of the sauna room 10 by one or two persons is assumed. Although not illustrated, it is preferable that a changing room equipped with a washbasin is provided adjacent to the sauna room 10. Hereinafter, devices and facilities disposed in the sauna room 10 will be described.

### Ventilation Device

As shown in FIG. 1A, a ventilation device 20 is disposed substantially at the center of a ceiling of the sauna room 10. The ventilation device 20 includes, for example, a device generally referred to as a bathroom dryer. In the present embodiment, the ventilation device 20 has four modes: a ventilation mode, a cool-air mode, a warm-air mode, and a drying mode. The ventilation device 20 may have only two modes, namely the ventilation mode and the warm-air mode, or may have additional modes such as a mist mode in addition to the four modes. The ventilation device 20 preferably includes at least a ventilation fan, a circulation fan, and a heat exchanger for air heating.

### Ventilation Mode

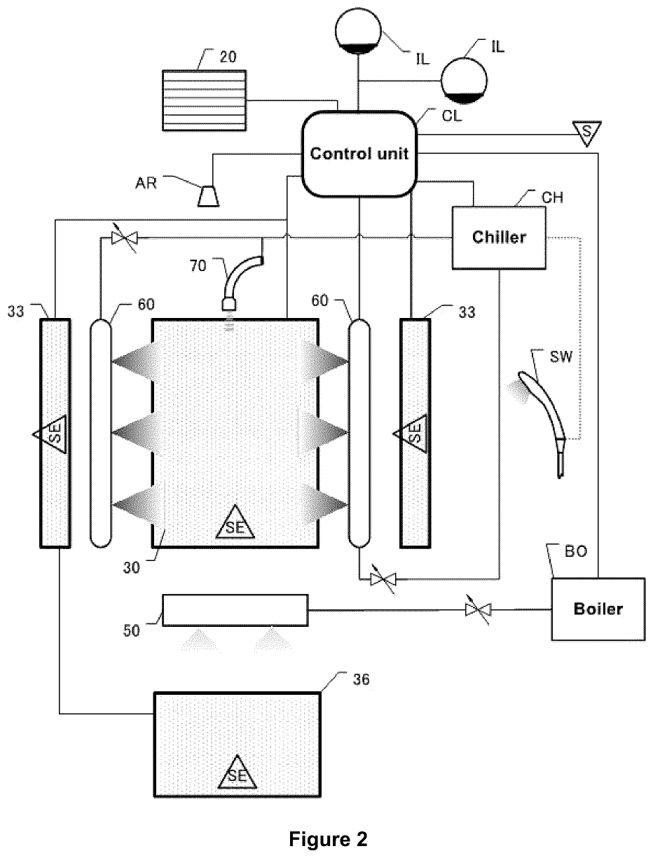

A control unit CL (see FIG. 2) executes a ventilation mode in which the ventilation fan is operated while the circulation fan and the heat exchanger for air heating are stopped. As a result, operation of the ventilation fan discharges air inside the sauna room to the outside, and in response to this discharge, outside air flows into the sauna room through a ventilation grille or the like provided in an entrance/exit door of the sauna room, thereby replacing the air inside the sauna room.

### Cool-air Mode

The control unit CL executes a cool-air mode in which the ventilation fan and the circulation fan are operated while the heat exchanger for air heating is stopped. As a result, operation of the ventilation fan discharges air inside the sauna room to the outside, and outside air flows into and replenishes the sauna room. In addition, operation of the circulation fan blows air inside the sauna room as cool air into the sauna room.

### Warm-air Mode

The control unit CL executes a warm-air mode in which the circulation fan is operated while the ventilation fan is stopped and a heat source is supplied to the heat exchanger for air heating. As a result, operation of the circulation fan blows air inside the sauna room, after being heated by the heat exchanger for air heating, into the sauna room as heating air.

### Drying Mode

The control unit CL executes a drying mode in which the ventilation fan and the circulation fan are operated while a heat source is supplied to the heat exchanger for air heating. As a result, operation of the ventilation fan discharges air inside the sauna room to the outside, and outside air flows into and replenishes the sauna room. In addition, operation of the circulation fan blows air inside the sauna room, after being heated by the heat exchanger for air heating, into the sauna room as drying air.

### First, Second, and Third Heating Sheets

In the present embodiment, a first heating sheet 30, a second heating sheet 33, and a third heating sheet 36 are far-infrared sheets. Specifically, the first heating sheet 30, the second heating sheet 33, and the third heating sheet 36 differ in installation locations and sizes within the sauna room, and their structures may be the same or different.

The first heating sheet 30 is disposed inside a seating surface ST, which will be described later, and particularly warms a user's back and buttocks. Depending on the shape of the seating surface ST, the first heating sheet 30 may also warm the user's legs (calf side), neck, and occipital region. In the present specification, the term “seating surface” refers not only to a surface on which the buttocks are placed, but also includes a surface on which the back is placed, and as necessary, surfaces on which the occipital region, the neck, or the legs are placed.

The second heating sheet 33 is disposed inside or outside a wall surface of the sauna room 10 adjacent to the seating surface ST, and warms an upper body and/or a lower body of the user. As shown in FIG. 1B, two second heating sheets 33 are disposed on both wall surfaces in the Y-axis direction of the seating surface ST, but the second heating sheet 33 may be disposed on only one of the wall surfaces.

The third heating sheet 36 is disposed inside a floor surface FL of the sauna room 10 and warms soles of the user's feet. However, the third heating sheet 36 does not necessarily have to be disposed in the sauna room 10.

The structures of the first heating sheet 30, the second heating sheet 33, and the third heating sheet 36 are preferably far-infrared sheets, and it is preferable that a temperature sensor SE is incorporated in each heating sheet. The heating sheets preferably have a surface temperature adjustable from 30° C. to 90° C. The heating sheets are electrically switchable ON/OFF.

The far-infrared sheets according to the present embodiment are obtained by glass-epoxy processing in which a sheet-shaped heating element provided with electrodes at both ends is packed with a plastic molding material composed of a pair of glass cloths and epoxy. The far-infrared sheet may further include an aluminum plate attached as a reflective layer, or a waterproof sheet (such as a PET film) attached to improve waterproof performance. The structures of the first heating sheet 30, the second heating sheet 33, and the third heating sheet 36 may all be the same or may be different from one another.

The sheet-shaped heating element may be a carbon sheet formed of high-strength carbon fibers or pulp, may be a metal sheet, or may be a sheet in which electric heating wires are woven. The present embodiment is not limited thereto, and appropriate modifications can be made.

### Superheated Steam Injection Device

The superheated steam injection device includes a superheated steam nozzle 50 and a boiler BO (see FIG. 2). The boiler BO is disposed outside the sauna room 10 and is capable of generating superheated steam at 300° C. to 400° C. using electricity, gas, or the like. A pipe from the boiler BO to the superheated steam nozzle 50 is, for example, a stainless-steel pipe, and the stainless-steel pipe is covered with a heat insulating material such as rock wool in order to prevent a temperature drop of the superheated steam. The superheated steam is sprayed from the superheated steam nozzle 50 having one or more openings.

In the present embodiment, the superheated steam nozzle 50 is preferably disposed around a lower side of the seating surface ST. This is because high-temperature superheated steam rises upward from bottom to top in the sauna room 10. The superheated steam sprayed from the superheated steam nozzle 50 can particularly warm an area around a user's lower legs. The superheated steam nozzle 50 may also be disposed below floor boards (grating), in which case soles of the user's feet or toes can be warmed. In addition, the superheated steam nozzle 50 can warm the entire interior of the sauna room 10.

### Cold Water Supply Device

The cold water supply device includes a chiller CH (see FIG. 2), a body shower 60, and a flexible faucet 70. The chiller CH is capable of continuously supplying cold water while circulating water within the chiller CH. In the present embodiment, the chiller CH can supply water at, for example, 5° C. to 20° C., preferably around 15° C., to the body shower 60 and the flexible faucet 70. In the present embodiment, the chiller CH does not supply cold water to a shower SW; however, it may be configured to do so.

The body shower 60 is formed of a metal pipe (for example, a stainless-steel pipe) or a plastic pipe having one end sealed, and a plurality of mist spray nozzles (not illustrated) are provided on a side surface of the metal pipe or the plastic pipe. The body shower 60 is disposed adjacent to both sides (Y-axis direction) or one side of the seating surface ST, and is arranged such that a longitudinal direction of the pipe extends in a height direction of the user (X-axis direction). Accordingly, cold water from the chiller CH is sprayed as mist-like cold water from the body shower 60 and falls over the entire body of the user, particularly the upper body. Although the body shower 60 shown in FIGS. 1A and 1(B) is illustrated as a straight pipe, it may be bent into a curved shape in accordance with the shape of the seating surface ST.

The flexible faucet 70 is disposed above a position corresponding to a head of a user seated on the seating surface ST, and allows the user to move a tip of the faucet using the user's own hand. By manually operating a faucet handle, the user can cause drop-like cold water to flow onto or stop flowing onto the user's forehead. In the present embodiment, the flexible faucet 70 is provided in the sauna room 10; however, it is not necessarily required to be provided.

### Seating Surface and Floor Surface

The seating surface ST and the floor surface FL are made of, for example, tiled material, radiant stone material, or wood such as cypress or cedar. Since the first heating sheet 30 is disposed inside the seating surface ST and the third heating sheet 36 is disposed in the floor surface FL as necessary, it is preferable to use wood dried to a moisture content of 20 percent or less so that the wood is not deformed or expanded by heat from the heating sheets. In the case of tiled material or radiant stone material, tiles or radiant stone may be directly attached onto the heating sheets, or tiles or radiant stone may be attached via structural plywood as necessary. The radiant stone material includes stone obtained by cutting and polishing radiant stone into a flat plate shape, or a material obtained by mixing crushed radiant stone with cement or the like or by sintering the mixture. Examples of the radiant stone include natural ores such as radon ore, feldspar, tourmaline (electric stone), radium ore, barley stone, granite, and tenju stone, as well as quartz, silica, artificial ceramics, and the like. The floor surface FL is slightly inclined so that water flows toward a drain DN.

### Lighting Fixtures and Aroma Diffuser

One or two or more lighting fixtures IL are disposed on a ceiling surface or wall surfaces in the sauna room 10. The lighting fixtures IL preferably include a dimming function and a color temperature adjustment function. The dimming function is a function that allows adjustment of brightness of lighting, and the color temperature adjustment function is a function that allows adjustment of a color of lighting from a warm color to a cool color. An aroma diffuser AR may be disposed in the sauna room 10. The aroma diffuser AR is preferably an electric type having a function of switching between release and stop of fragrance. The aroma diffuser AR is preferably disposed around a head of a user seated on the seating surface.

### Control of Sauna Room

FIG. 2 is a diagram showing relationships between a ventilation device 20, a first heating sheet 30, a superheated steam nozzle 50, a body shower 60, and the like disposed in the sauna room 10, and a control unit CL.

The control unit CL according to the present embodiment is, for example, a smartphone or a tablet on which an application has been downloaded, and the control unit CL is capable of controlling the ventilation device 20, the first heating sheet 30, the superheated steam injection device, and the like. Alternatively, the control unit CL may be configured by control units housed in separate casings. For example, a control unit cl1 that controls only the ventilation device 20, a control unit cl2 that controls only the first, second, and third heating sheets, a control unit cl3 that controls only the superheated steam injection device (the boiler BO and valves), a control unit cl4 that controls only the cold water supply device (the chiller CH and valves, etc.), a control unit cl5 that controls only the lighting fixtures IL, and a control unit cl6 that controls only the aroma diffuser may each be provided in separate casings. In this case, it is preferable that the control units in the separate casings are configured to transmit and receive commands to and from one another.

The control unit CL is capable of switching the ventilation device 20 among four modes, namely a ventilation mode, a cool-air mode, a warm-air mode, and a drying mode, based on or without being based on input from a temperature sensor S that measures an indoor temperature. In addition, the control unit CL electrically controls ON/OFF of the first heating sheet 30, the second heating sheet 33, and the third heating sheet 36, and is capable of setting temperatures of the first heating sheet 30, the second heating sheet 33, and the third heating sheet 36, respectively, based on input from temperature sensors SE incorporated in the heating sheets. Furthermore, the control unit CL is capable of adjusting a temperature of superheated steam generated by the boiler BO based on input from the temperature sensor S that measures the indoor temperature, and of controlling spraying and stopping of superheated steam from the superheated steam nozzle 50.

The control unit CL is capable of adjusting a temperature of cold water generated by the chiller CH and of controlling supply and stop of cold water to the body shower 60. Furthermore, the control unit CL is capable of performing dimming and/or color temperature adjustment of the lighting fixtures IL, and is also capable of controlling release and stop of fragrance from the aroma diffuser AR.

### Method of Using Sauna Room

In general, a user performs sauna→cold-water bath→resting (or sauna→cold-water bath→sauna→cold-water bath→resting) as one set, and repeats the set two to three times. In the present embodiment, in order to allow repetition of sauna→cold-water bath→resting within a single sauna room 10, switching steps are included, and sauna→switching 1→cold-water bath→switching 2→resting constitutes one set. The control unit CL may switch between a sauna state, a cold-water bath state, and a resting state by a timer, or may switch between the sauna state, the cold-water bath state, and the resting state when the user presses a switch of the control unit CL.

### Method of Use 1

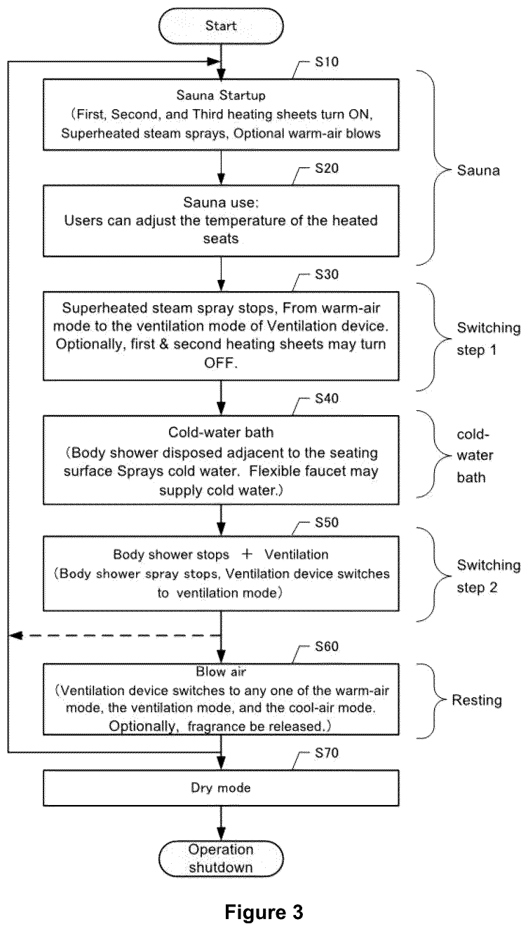

Method of Use 1 is explained with reference to FIG. 3. In step S10, the control unit CL controls the first, second, and third heating sheets (30, 33, 36) so that the interior of the sauna room 10 reaches a predetermined temperature, by setting each heating sheet to a respective set temperature. For example, the control unit CL sets the first heating sheet 30 to 40-60° C., the second heating sheet 33 to 50-70° C., and the third heating sheet 36 to 45-65° C. As a result, a surface temperature of the seating surface ST becomes about 30-50° C., a surface temperature of wall surfaces becomes about 40-60° C., and a surface temperature of the floor surface FL becomes about 35-55° C.

Since wall surfaces heated by the second heating sheet 33 are less likely to directly contact a user's skin, it is preferable to set the temperature of the second heating sheet 33 higher than those of the first heating sheet 30 and the third heating sheet 36. In addition, the control unit CL controls superheated steam to be sprayed from the superheated steam nozzle 50. The ventilation device 20 may be stopped; however, as necessary, the control unit CL may control the ventilation device 20 to the warm-air mode to blow heating air into the sauna room. A sauna startup time is, for example, 5 to 10 minutes.

In step S20, the user enters the sauna room 10, washes the body using a shower SW, and then sits on the seating surface ST. The user can change temperatures of the first, second, and third heating sheets (30, 33, 36) using the control unit CL. The sauna entry step (S20) is, for example, 8 to 15 minutes. If the ventilation device 20 is not blowing air in step S10, the control unit CL controls the ventilation device 20 to the warm-air mode to circulate air in the sauna room and equalize humidity and temperature (also referred to as “aufguss”). In addition, based on input from the temperature sensor S that measures the indoor temperature, the control unit CL controls a temperature of the superheated steam. The control unit CL preferably dims the lighting fixtures IL to a darker brightness with a warm color tone.

Step S30 is a switching step from the sauna state to the cold-water bath state. The control unit CL stops spraying of superheated steam from the superheated steam nozzle 50 and switches the ventilation device 20 from the warm-air mode to the ventilation mode. As a result, the indoor temperature of the sauna room 10 is lowered by 10° C. or more within several minutes. Furthermore, the control unit CL may keep the first, second, and third heating sheets (30, 33, 36) turned ON while maintaining their temperatures or lowering their temperatures. Since the first heating sheet 30 and the third heating sheet 36 are disposed inside the seating surface ST and the floor surface FL, respectively, and the second heating sheet 33 is also optionally disposed inside wall surfaces, once the temperatures of the heating sheets are lowered, the temperatures of the seating surface ST, the floor surface FL, and the wall surfaces are difficult to raise again. Therefore, the control unit CL does not turn OFF the first, second, and third heating sheets (30, 33, 36), but maintains them at the set temperatures or lowers them by 5-10° C.

In step S40, the control unit CL starts supplying cold water to the body shower 60 so that cold water is applied to the entire body of the user. The user can also adjust the temperature of cold water generated by the chiller CH using the control unit CL. Based on input from the temperature sensor S that measures the indoor temperature, the control unit CL controls the ventilation device 20 to any one of the warm-air mode, the ventilation mode, and the cool-air mode. For example, in winter, since the temperature detected by the temperature sensor S tends to be lower than a predetermined value, the ventilation device 20 is controlled to the warm-air mode, whereas in summer, since the temperature tends to be higher than the predetermined value, the ventilation device 20 is controlled to the cool-air mode. Step S40 is, for example, 2 to 4 minutes. The control unit CL preferably adjusts the lighting fixtures IL to a color tone having a strong bluish tint.

Step S50 is a switching step from the cold-water bath state to the resting state. The control unit CL stops supplying cold water to the body shower 60 and switches the ventilation device 20 to the ventilation mode. After step S50, if the process proceeds in a dotted-line direction and returns to step S10, switching from the cold-water bath state to the sauna state is performed. That is, sauna→cold-water bath→sauna→cold-water bath can be repeated.

Step S60 is a resting state. Based on input from the temperature sensor S that measures the indoor temperature, the control unit CL controls the ventilation device 20 to any one of the warm-air mode, the ventilation mode, and the cool-air mode. In addition, as necessary, the control unit CL causes fragrance to be released from the aroma diffuser AR. Step S60 is, for example, 10 to 20 minutes.

After several sets of sauna→cold-water bath→resting have elapsed, the process proceeds to step S70. Step S70 is a drying step of the sauna room 10. The control unit CL operates the ventilation device 20 in the ventilation mode for one hour or more to dry the sauna room 10.

### Method of Use 2

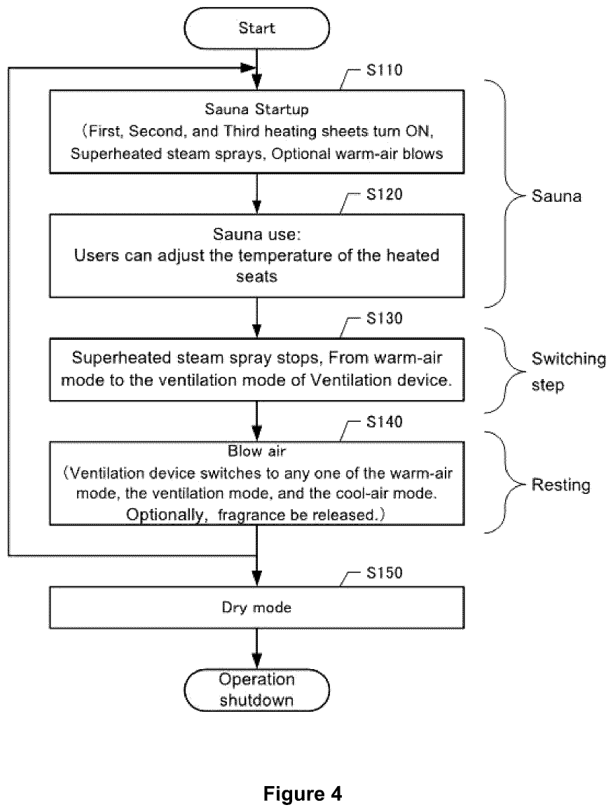

Method of Use 2 is explained with reference to FIG. 4. Method of Use 2 is an example in which a cold-water bath is not used, and sauna→resting constitutes one set, which is repeated two to three times.

Step S110 is the same as step S10 of Method of Use 1. Step S120 is also the same as step S20 of Method of Use 1.

Step S130 is a switching step from the sauna state to the resting state. The control unit CL stops spraying of superheated steam from the superheated steam nozzle 50 and switches the ventilation device 20 from the warm-air mode to the ventilation mode. As a result, the indoor temperature of the sauna room 10 is lowered by 10° C. or more within several minutes. Furthermore, the control unit CL may keep the first, second, and third heating sheets (30, 33, 36) turned ON while maintaining their temperatures or lowering their temperatures by 5-10° C.

Step S140 is a resting state. Based on input from the temperature sensor S that measures the indoor temperature of the sauna room, the control unit CL controls the ventilation device 20 to any one of the warm-air mode, the ventilation mode, and the cool-air mode.

After several sets of sauna→resting have elapsed, the process proceeds to step S150. Step S150 is a drying step of the sauna room 10. The control unit CL operates the ventilation device 20 in the ventilation mode for one hour or more to dry the sauna room 10.

### Method of Use 3

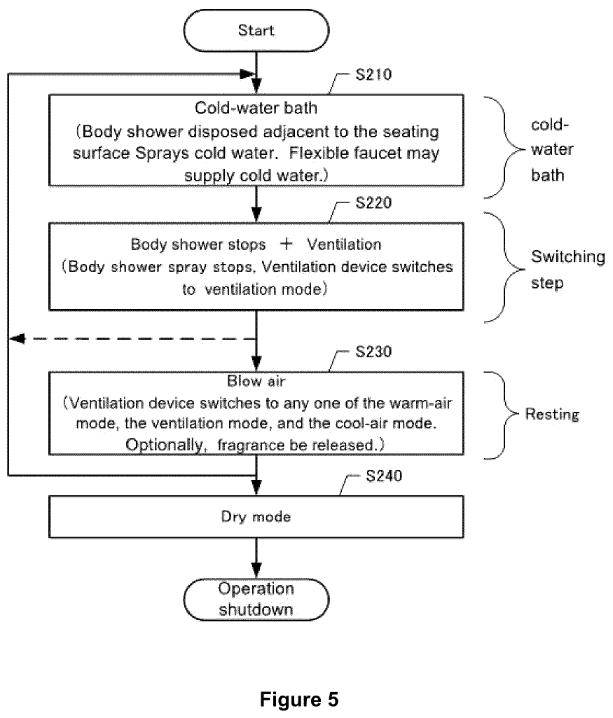

Method of Use 3 is explained with reference to FIG. 5. Method of Use 3 is an example in which a sauna is not used, and cold-water bath→resting constitutes one set, which is repeated two to three times.

In step S210, based on input from the temperature sensor S that measures the indoor temperature of the sauna room, the control unit CL controls the ventilation device 20 to any one of the warm-air mode, the ventilation mode, and the cool-air mode, and also turns the first, second, and third heating sheets (30, 33, 36) ON or keeps them OFF. In summer, the temperature inside the sauna room 10 without ventilation may exceed 30° C., and in such a case, the control unit CL controls the ventilation device 20 in the ventilation mode or the cool-air mode while keeping the first, second, and third heating sheets OFF. In winter, the temperature inside the sauna room 10 without ventilation may fall below 10° C., and in such a case, the control unit CL controls the ventilation device 20 in the warm-air mode while turning the first, second, and third heating sheets ON.

Furthermore, the control unit CL starts supplying cold water to the body shower 60 so that cold water is applied to the entire body of the user. The user can also adjust the temperature of cold water generated by the chiller CH using the control unit CL.

Step S220 is a switching step from the cold-water bath state to the resting state. The control unit CL stops supplying cold water to the body shower 60 and switches the ventilation device 20 to the ventilation mode.

Step S230 is a resting state. Based on input from the temperature sensor S that measures the indoor temperature, the control unit CL controls the ventilation device 20 to any one of the warm-air mode, the ventilation mode, and the cool-air mode. In addition, as necessary, the control unit CL causes fragrance to be released from the aroma diffuser AR.

After several sets of cold-water bath→resting have elapsed, the process proceeds to step S240. Step S240 is a drying step of the sauna room 10. The control unit CL operates the ventilation device 20 in the ventilation mode for one hour or more to dry the sauna room 10.

Although the sauna room for carrying out the present invention has been described above, the present invention is not limited in any way to these embodiments. For example, a user may use only the sauna or only the cold-water bath. Various modifications and substitutions may be made without departing from the gist of the present invention.

### DESCRIPTION OF REFERENCE NUMERALS

10: Sauna room
20: Ventilation device
30: First heating sheet
33: Second heating sheet
36: Third heating sheet
50: Superheated steam nozzle
60: Body shower
70: Flexible faucet
AR: Aroma diffuser
BO: Boiler
CH: Chiller
CL: Control unit
FL: Floor surface
IL: Lighting fixture
S, SE: Temperature sensor
ST: Seating surface
SW: Shower

What is claimed is:

1. A sauna room configured to create a sauna state and a cold-water bath state within a single room having a first wall surface and a second wall surface, comprising:
a first heating sheet disposed on a seating surface and electrically switchable between an ON state and an OFF state;
a second heating sheet disposed on at least one of the first wall surface and the second wall surface adjacent to the seating surface and electrically switchable between an ON state and an OFF state;
a body shower disposed on at least one of (a) between a first side of the seating surface and the first wall surface, and (b) between a second side of the seating surface and the second wall surface, the body shower being configured to spray and stop cold water through one or more nozzles; and
a control unit configured to control the first heating sheet, the second heating sheet, and the body shower, wherein
in the sauna state, the control unit turns the first heating sheet and the second heating sheet to their respective ON states, and
in the cold-water bath state, the control unit keeps the first heating sheet and the second heating sheet in their respective ON states and sprays water from the body shower in the cold-water bath state.

2. The sauna room according to claim 1, further comprising a superheated steam nozzle disposed around the seating surface and configured to alternately spray and stop superheated steam, wherein
in the sauna state, the control unit sprays superheated steam from the superheated steam nozzle, stops
in the cold-water bath state, the superheated steam nozzle.

3. The sauna room according to claim 1, wherein in the sauna state, the control unit sets the first heating sheet to a first temperature and sets the second heating sheet to a second temperature higher than the first temperature.

4. The sauna room according to claim 1, wherein the body shower includes a pipe that extends in a longitudinal direction and is disposed along a longitudinal direction of the seating surface.

5. The sauna room according to claim 1, further comprising a ventilation device disposed in the sauna room and configured to switch between a warm-air mode, a ventilation mode, and a cool-air mode, wherein
in the sauna state, the control unit sets the ventilation device to the warm-air mode.

6. The sauna room according to claim 1, further comprising:
a ventilation device disposed in the sauna room and configured to switch between a warm-air mode, a ventilation mode, and a cool-air mode; and
a temperature sensor disposed in the sauna room and configured to measure an indoor temperature of the sauna room, wherein
the sauna room is configured to create a resting state in which the control unit (a) switches the ventilation device to the warm-air mode, the ventilation mode, or the cool-air mode, (b) causes air to be blown in accordance with the indoor temperature of the sauna room measured by the temperature sensor, and (c) stops spraying of the body shower.

7. The sauna room according to claim 6, wherein, at the start of transition to the sauna state, the control unit turns the first heating sheet and the second heating sheet to their respective ON states, and causes the ventilation device to blow air in the warm-air mode.
